(19) United States
(12) Patent Application Publication
(10) Pub. No.: US 2008/0069375 A1
(43) Pub. Date: Mar. 20, 2008

(54) Cancellation of contact artifacts in a differential electrophysiological signal

(76) Inventor: Daniel H. Lange, Kfar Vradim (IL)

Correspondence Address: JONES DAY, 555 SOUTH FLOWER STREET FIFTIETH FLOOR, LOS ANGELES, CA, 90071, US

(21) Appl. No.: 11/901,460

(22) Filed: Sep. 17, 2007

Related U.S. Application Data
(60) Provisional application No. 60/844,928, filed on Sep. 15, 2006.

(51) Int. Cl. H04B 15/00

(52) U.S. Cl. 381/94.4

(57) ABSTRACT

The present invention discloses a method for cancellation of local contact artifacts from differential recordings of electrophysiological signals, using reference inputs for modeling of the noise expressions in the composite differential signals

This application claims the benefit of U.S. Provisional Application Ser. No. 60/844,928, filed Sep. 15, 2006.

### FIELD OF THE INVENTION

The field of the present invention relates to cancellation of local contact artifacts from electrophysiological signals. More particularly, the field of the present invention relates to methods for elimination of local artifacts generated at or near the recording site from a composite differential signal comprised of a desired differential signal and noise.

### BACKGROUND OF THE INVENTION

Bio-electric recordings such electroencephalograms (EEG), electrocardiograms (ECG), and electromyograms (EMG), are typically acquired using Ag—AgCl electrodes attached to the subject's skin. Wet or hydrophilic conductive gels are used to optimize contact with the skin and increase skin conductance, thereby enhancing the acquired signal quality.

Further improvement of galvanic contact may be achieved by mild skin abrasion to scrape off dead skin tissue. This is a common procedure in medical practice. However, in noisy clinical environments such as during exercise (e.g. stress-test ECG) or in non-clinical settings (e.g. physical training), movement artifacts tend to contaminate the recordings and sometimes completely mask out the signal. In addition, in non-professional clinical environments such as remote medical monitoring, simplified electrode usage is desired and often dry electrodes must be used. This further increases susceptibility to motion artifacts since the dry outer layer skin functions as a dielectric isolator causing ionic charge buildup and thereby inducing parasitic voltage fluctuations with even the slightest movement.

Thus there exists a clear need to eliminate local noise generated by a subject's interaction with a sensor contact.

As described herein, we use local noise reference inputs to cancel contact artifacts by adding appropriate amplification channels responsible for independent measurement of locally generated noise, and applying adaptive cancellation techniques to eliminate the noise contribution to the desired signal.

By way of example, the following discussion shall focus on ECG signal analysis, however the same principles hold for noise elimination from other bio-signals such as EEG and EMG.

### SUMMARY OF THE INVENTION

The present invention discloses a method for cancellation of local contact artifacts from differential recordings of electrophysiological signals, using reference inputs for modeling of the noise expressions in the composite differential signals.

In a preferred embodiment, the method described herein reconstructs the noise contribution to the measured composite differential signal (which is comprised of a desired differential signal and noise) and subtracts the noise contribution from the composite differential signal thereby providing a high-quality representation of the desired differential signal.

We also provide a method to eliminate electrophysiological sensor contact artifacts in a composite differential signal comprising the steps of

(a) simultaneously and separately recording noise and a composite differential signal at a recording site;

(b) identifying a transform that may be used to transform the separately recorded noise into an approximation of noise present in the composite signal;

(c) reconstructing the noise present in the composite signal using the transformed recorded noise;

(d) canceling the noise present in the composite signal using the reconstructed noise.

The foregoing method may have a recording step that comprises recording with a split sensor. The foregoing method may also be done so that the transform and reconstruction steps are done on a synchronized noise block and signal block and the cancellation step includes taking consecutive synchronized signal and noise blocks and performing a batch least square fitting of the noise blocks onto the signal blocks followed by removal of the fitted noise blocks from the signal blocks.

### DETAILED DESCRIPTION

The ECG is a periodic signal reflecting heart contraction and relaxation. Typical heart rate ranges from 60-70 beats per minute during rest, and may double and even triple during intense physical or psychological activity. Unstable acquisition conditions, such as during physical activity or due to instabilities related to natural or patho-physiological phenomena such as tremor, give rise to local measurement artifacts. These artifacts appear in a wide range of frequencies, with spectral characteristics significantly overlapping that of the desired signal, thus preventing use of conventional spectral filtering for signal enhancement. Complete masking of the desired signal in unstable acquisition conditions is not uncommon.

It will henceforth be shown that local measurement of artifacts provides a viable reference input for artifact cancellation from the desired signal. By way of example, we shall consider a setup where a differential ECG signal is acquired from two fingers, one of each hand, using dry electrode plates appropriate for repeated usage. On one hand, it is a realistic scenario in widely used applications such as remote medicine application or heart rate monitoring during cycling, yet it is particularly problematic due to the following reasons: (a) dry electrodes provide poor contact; (b) free touching may introduce motion artifacts even under apparent stationary conditions, let alone non-stationary conditions; and (c) ECG signal amplitude captured from the fingers or hands is much attenuated due to the distance from the generating tissue, resulting in low SNR recordings.

In one embodiment, artifact cancellation is performed by simultaneous recordings of noise-only data from the fingers' surface, and of a differential signal between left and right fingers, as depicted in FIG. 1. In other embodiments, other recording sites such as chest, back, or limbs, may be used.

In one embodiment, block signal analysis is used for artifact cancellation, taking consecutive synchronized signal and noise blocks and performing a batch least-square fitting of the noise block onto the signal block followed by removal of the fitted noise block from the signal block. In another embodiment, to optimize adaptive performance, overlapping blocks are used. In yet another embodiment, depending on real-time requirements of the specific application, sequential analysis is performed on a sample by sample basis using adaptive fitting techniques such as LMS or RLS. B. W. Widrow, S. D. Stearns, “Adaptive Signal Processing,” 1985, Prentice-Hall, Inc., New Jersey.

In one embodiment, the contact sensor plates are divided into two reception zones to allow for both a local surface noise recording from the left and right fingers, as well as for a differential recording between the two fingers to capture the differential ECG signal. In other embodiments, the contact sensor plates may be divided into multiple reception zones, to provide higher spatial noise resolution mapping.

In one embodiment, the local surface noise data is adaptively eliminated from the desired differential signal, using an adaptive cancellation scheme as presented in FIG. 2, where the adaptive block LS (least squares) controls the adaptation process of the noise input filters A(z), B(z). In alternative embodiments, other cancellation schemes such as adaptive line enhancement may be used.

### EXAMPLE

The following example demonstrates the benefit of contact artifact cancellation for ECG monitoring. A subject was instructed to touch both left and right sensor plates with two fingers of two hands. He was then instructed to move his right finger in cyclic motion, while maintaining contact with the sensor plate, thereby introducing strong movement artifacts into the desired ECG signal. Adaptive cancellation of the reference noise signals is implemented by means of batch least squares fitting to eliminate the noise influence on the ECG signal. FIG. 3 shows the noise contaminated ECG signal (top), the reference noise signal acquired from the surface of the moving finger (middle), and the noise-eliminated ECG signal (bottom).

Noise cancellation was implemented in block analysis, as follows:

Let n₁(t) and n₂(t) denote the contact noise readings measured from the right and left fingers, and let S(t) denote the composite differential signal measured between the left and right fingers.

Assuming the noise recordings are taken from a close recording site, we can consider them to be linearly related to the contact noise measured differentially from the left and right fingers.

S(t)=ECG(t)+n(t)

Cancellation of the contact noise n(t) is thus feasible by fitting of linearly transformed noise signals to the measured differential signal:

S(t)=ECG(t)+n₁(t)*a(t)+n₂(t)*b(t)

where a(t), b(t) are impulse responses of time-variant linear filters.

To solve the time variant optimization problem, we shall assume quasi-stationarity of the solution, i.e., apply block analysis to solve the following optimization problem:

MIN∥S(t)−{n₁(t)*a(t)+n₂(t)*b(t)}∥

In discrete matrix notation, we provide a least-squares solution as follows: Let N denote the right and left noise matrix:

$$N = [ \begin{matrix}{n}_{1} ( 1 ) & {n}_{1} ( 2 ) & ⋯ & {n}_{1} ( p ) \\ {n}_{2} ( 1 ) & {n}_{2} ( 2 ) & ⋯ & {n}_{2} ( p )\end{matrix} ]$$

Let S denote the signal vector:

S=[S(1)S(2) . . . S(p)]

The least square solution is:

$$C = [ \begin{matrix}a \\ b\end{matrix} ] = S \cdot {N}^{T} \cdot {( N \cdot {N}^{T} )}^{- 1}$$

And thus the ECG signal can be reconstructed as follows:

$$ECG = S - C \cdot N$$

### DESCRIPTION OF THE FIGURES

FIG. 1 is a signal flow diagram of a proposed signal and noise recording circuit.

FIG. 2 is a schematic diagram of an adaptive noise cancellation method wherein LS stands for Least Squares block, which is the adaptive block controlling the adaptation process of the noise input filters A(z), B(z).

FIG. 3 is a comparison of a raw composite ECG signal with a processed ECG signal obtained by removing the noise reference according to a preferred embodiment.

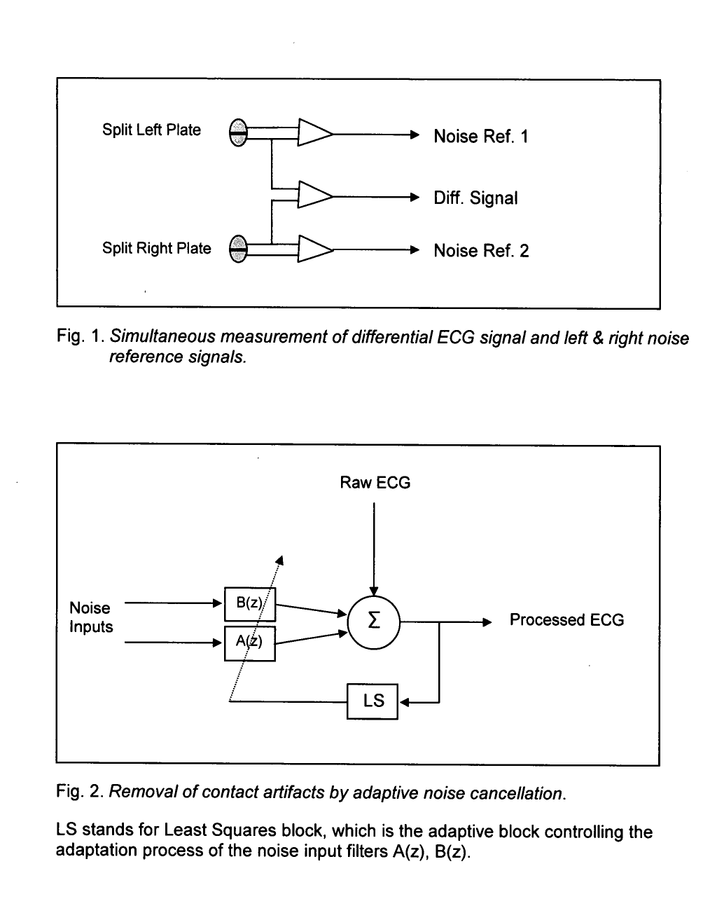

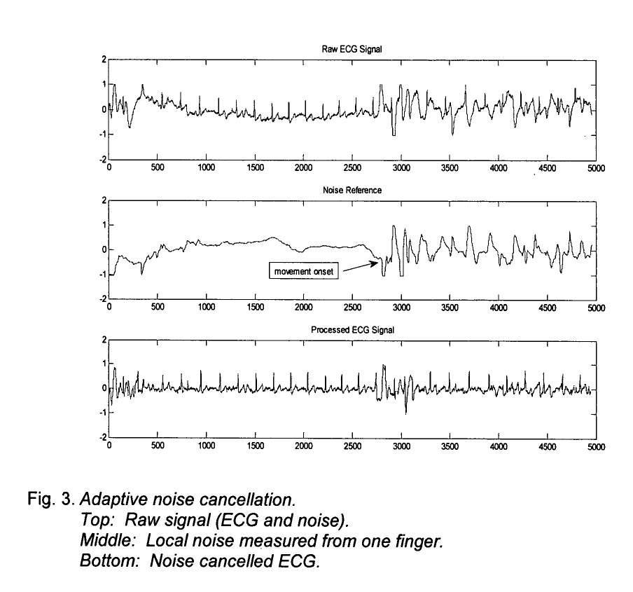

What is claimed:

1. A method to eliminate electrophysiological sensor contact artifacts in a composite differential signal comprising the steps of
(a) simultaneously and separately recording noise and a composite differential signal at a recording site;
(b) identifying a transform that may be used to transform the separately recorded noise into an approximation of noise present in the composite signal;
(c) reconstructing the noise present in the composite signal using the transformed recorded noise;
(d) canceling the noise present in the composite signal using the reconstructed noise.

2. The method of claim 1 wherein the recording step records with a split sensor.

3. The method of claim 1 whereby the transform and reconstruction steps are done on a synchronized noise block and signal block.

4. A method for cancellation of local artifacts from differential recordings of electrophysiological signals comprising the steps of
(a) reconstructing a noise contribution to a measured composite differential signal that comprises desired differential signal and noise;
(b) subtracting the noise contribution from the composite differential signal.
(c) providing a representation of the desired differential signal.

5. The method of claim 3 further comprising the steps of performing a batch least square fitting of noise blocks and removing the fitted noise blocks from the signal blocks.
